(19) United States
(12) Patent Application Publication
(10) Pub. No.: US 2010/0281719 A1
(43) Pub. Date: Nov. 11, 2010

(54) ELECTRICALLY POWERED DYNAMIC GIFT ARTIFACT

(75) Inventor: Franciscus August Aaron Driessen, Amsterdam (NL)

Correspondence Address: KNOBBE MARTENS OLSON & BEAR LLP, 2040 MAIN STREET, FOURTEENTH FLOOR, IRVINE, CA, 92614, US

(73) Assignees: Quiham BV, Utrecht (NL); F.A. Driessen BV, Utrecht (NL)

(21) Appl. No.: 12/436,719

(22) Filed: May 6, 2009

(51) Int. Cl. G09F 1/00; B42D 15/00

(52) U.S. Cl. 40/124.02; 283/85

(57) ABSTRACT

An electrically-powered, dynamic light-emitting gift artifact is disclosed having a light emitting component adapted switchably to emit light between two or more different colors, and a translucent substrate window on which two or more superimposed layers of artwork are disposed. The light emitting component is located for projection through the translucent substrate, and the visibility of each layer of artwork in the window changes responsive to emissions by the light emitting component.

### FIELD OF THE INVENTION

The present invention relates to dynamic, powered gift artifacts such as greetings cards, mouse-mats, door-hangers and promotional items, that activate when viewed or handled by a user, for example, to illuminate dynamically part of the artifact, and optionally to provide sound effects.

### BACKGROUND OF THE INVENTION

Electrically-powered, dynamic gift artifacts, particularly greeting cards and other paper based communication media, can provide the recipient with dynamic visual and aural stimuli, that are typically produced upon a mechanical activation, such as opening the card or pressing an activation button, supporting and enhancing static graphic information provided on the surfaces of the artifact.

In some of such artifacts, the static artwork is enhanced dynamically using partially translucent materials provided with light emitting components placed behind it, that, upon activation, illuminate portions of the artwork as an outlined shape that is not visible while those light emitting components are not activated. Particularly such artwork consists of dynamically lit-up alphanumerical characters or other figures and symbols.

A problem associated with such artifacts is that the extension of the static artwork with the dynamic illumination of portions of the artwork, consists of only two simple states, i.e. a state in which the additional artwork is illuminated and thus visible, and a state in which it is not. Another problem of such artifacts is that the illuminated artwork is limited to outlined shapes.

There is a need in the art for electrically powered, dynamic gift artifacts, that provide an enhancement of the static graphic content with graphic content that consists of 2, 3, 4 or more illuminated states and the enhancement of the illuminated graphic content with artwork inside the outline of the illuminated shape, resulting in dynamic graphic content that may be generally perceived as animation of the artwork.

Particularly there is a need in the art for electrically powered, dynamic gift artifacts, of such multi-state illumination in cases where the graphic content portrays features and objects that are naturally dynamic, such as facial features and limbs of natural characters and of cartoon characters.

### SUMMARY OF THE INVENTION

The present invention concerns an electrically-powered, dynamic light-emitting gift artifact comprising:
a light emitting component adapted switchably to emit light of two or more different colors,
a translucent substrate on which two or more individual layers of artwork are disposed, wherein:
the light emitting component is located for projection through the translucent substrate, and
the visibility of each layer of artwork changes responsive to emissions by the light emitting component.

The gift artifact is generally, though not necessarily, a greeting card, and is provided with integrated electronic components configured to control the color emitted by the light emitting components placed in the artifact. It may additionally be provided with a sonic transducer to generate audio signals, which may be synchronized with the light and color emissions.

The artwork may be a graphic illustration, alphanumeric text. In particular, it may be a part of a facial expression such as the eyes, eye brows, mouth, nose.

The artwork layers may be disposed on one or both sides of a translucent substrate. They are overlaid or superimposed, one over the other so forming a multilayered artwork. The artwork layers are preferably printed, one over the other.

The printing inks used in the multi-layered printed artwork are of such a composition that they are visible depending on the color of back-illumination provided by the light-emitting component projecting through the substrate. For instance, upon emission of light of one color by the light emitting component, only one of the layers of artwork is illuminated, while the other layers remain less visible or not visible at all. When light emitted by the light emitting component is switched to another color, another layer may become visible. Thus, 2, 3, 4 or more different layers of the artwork may be back-illuminated in the same location as or in slight displacement from a topmost printed graphic image, whereby the corresponding part of the topmost printed image becomes less apparent than the illuminated artwork that shines through.

In a particular embodiment of the present invention as a greeting card, the foremost printed image represents a male and a female cartoon character, of which the faces are depicted with a closed mouth and closed eyes. In consecutive layers of the multilayered printed artwork, different states of the cartoon characters' eyes and mouths are depicted on each separate layer. In one layer, the eyes and mouths express anger, and in another layer the eyes and mouths express joy. Upon activation of a corresponding light-emitting component, which emits light of a particular spectral profile of which the ink used in one the artwork layers is able to filter out or react with luminescently, that artwork of said layer is illuminated in such a way that it becomes visible, whereas another layer of artwork, having a different ink, is not seen. The latter becomes visible when the light-emitting component emits light of a different spectral profile which the different ink is able to filter out.

By sequentially switching the spectral emission profiles of the light emitting component, the different states of the characters faces as printed in the different layers of the multi-layered printing are individually illuminated, resulting in the faces of the characters changing sequentially, and transitioning between an expression of joy and anger.

In another particular embodiment of the present invention as a greeting card, the foremost printed artwork represents a cartoon character whose hands are depicted as clenched fists. On consecutive layers of the multi-layered printing, the hands of the character are depicted in the ‘thumbs-up’ position and in another consecutive layer the hands are depicted as opened hands. Upon activation of the corresponding light emitting components, the hands may be illuminated sequentially in such a way that either the ‘thumbs-up’ state may become visible or the ‘hands-open’ state may become visible.

One embodiment of the invention is an electrically-powered, dynamic light-emitting gift artifact comprising:
a light emitting component adapted switchably to emit light of two or more different colors,
a translucent substrate window on which two or more superimposed layers of artwork are disposed,

wherein:
the light emitting component is located for projection through the translucent substrate, and
the visibility of each layer of artwork in the window changes responsive to emissions by the light emitting component.

Another embodiment of the invention is an artifact as described above, wherein at least one of the layers of artwork is printed using a selective light-filtering ink, where one of the two colors emitted by the light emitting component substantially passes through the ink, and the other of the two colors emitted by the light emitting component substantially does not.

Another embodiment of the invention is an artifact as described above, wherein
a first layer of the overlapping layers of artwork is printed using a first selective light-filtering ink, where a first color emitted by the light emitting component substantially passes through the first ink, and a second color emitted by the light emitting component substantially does not,
a second layer of the overlapping layers of artwork is printed using a second selective light-filtering ink, where the second color emitted by the light emitting component substantially passes through the second ink, and the first emitted by the light emitting component substantially does not.

Another embodiment of the invention is an artifact as described above, wherein at least one of the superimposed layers of artwork is a topmost layer of artwork visible to the viewer without from the light emitting component.

Another embodiment of the invention is an artifact as described above, further comprising a processing component operably connected to the light emitting component, adapted to control the sequence of emissions by the light emitting component.

Another embodiment of the invention is an artifact as described above, wherein the number of light emitting components is 1, 2, 3, 4, 5, 6, 7, 8, 9, 10 or more.

Another embodiment of the invention is an artifact as described above, wherein the light-emitting component comprises two or more separately powered illumination sources, each emitting light of a different color.

Another embodiment of the invention is an artifact as described above, further comprising a sonic transducer, operably connected to the processing component, whereby the processing component is further adapted to synchronise emissions by the light emitting component with emission of sound from the sonic transducer.

Another embodiment of the invention is an artifact as described above, further comprising an activator such an electrical contacts, motion sensor, or microphone.

Another embodiment of the invention is an artifact as described above, that is a greeting card.

Another embodiment of the invention is an artifact as described above, that is a mouse mat.

### FIGURE LEGENDS

FIGS. 1 to 3 provide a schematic indication of the principle of the invention. FIG. 1 shows the default state i.e. no back-illumination; FIG. 2 shows one state when back-illumination is provided by light of one color; FIG. 3 shows another state when back-illumination is provided by light of another color; the letters “r o y g b i v” respectively refer to spectral colors red, orange, yellow, green, blue, indigo, and violet.

FIG. 4 is an illustration of a translucent substrate provided with an example of the multiple layers of artwork.

FIG. 5 is an illustration showing an example of different layers that are applied to the translucent substrate as multi-layer printing as shown in FIG. 4.

FIG. 6 Is an illustration in the form of an exploded view of a construction of the multi-layer printed translucent substrate of FIGS. 4 and 5 and light-emitting components.

FIG. 7 is an illustration of an opened-out paper based communication medium that is a greeting card provided with the translucent substrate with multi-layer printing and containing electrical components for sound reproduction and light emitting components for illuminating the different states of the artwork in the multi-layered printing, as in FIGS. 4, 5 and 6.

FIG. 8 is an embodiment of the invention in a greeting card as depicted in FIG. 8

FIG. 9. Is an illustration of different illuminated states of an example of artwork applied in multi-layer printing of FIGS. 4, 5, 6, 7 and 8.

FIG. 10 is an illustration of a translucent substrate provided with another example of the multiple layers of artwork applied.

FIG. 11 is an illustration showing an example of different layers that are applied to the translucent substrate as multi-layer printing as shown in FIG. 10.

FIG. 12 is an illustration in the form of an exploded view of an embodiment of the invention as a mouse mat provided with the translucent substrate with multi-layer printing and containing electrical components for sound reproduction and light emitting components for illuminating the different states of the artwork in the multi-layered printing, as in FIGS. 10 and 11.

FIG. 13 is the embodiment as a mouse mat of FIGS. 10, 11 and 12 completely assembled.

FIG. 14 is an illustration of examples of different illuminated states of the example of artwork applied in multi-layer printing of FIGS. 10, 11, 12 and 13

FIG. 15 depicts a circuit diagram for connecting the electrical components of the invention.

FIG. 16 depicts a PCB layout for mounting and connecting the electrical components of the invention.

### DETAILED DESCRIPTION OF THE INVENTION

Unless defined otherwise, all technical and scientific terms used herein have the same meaning as is commonly understood by one of skill in the art. All publications referenced herein are incorporated by reference thereto. All United States patents and patent applications referenced herein are incorporated by reference herein in their entirety including the drawings.

The articles “a” and “an” are used herein to refer to one or to more than one, i.e. to at least one of the grammatical object of the article. By way of example, “an integrated circuit” means one integrated circuit or more than one integrated circuit.

The recitation of numerical ranges by endpoints includes all integer numbers and, where appropriate, fractions subsumed within that range (e.g. 1 to 5 can include 1, 2, 3, 4 when referring to, for example, a number of integrated circuits, and can also include 1.5, 2, 2.75 and 3.80, when referring to, for example, measurements). The recitation of end points also includes the end point values themselves (e.g. from 1.0 to 5.0 includes both 1.0 and 5.0).

The present invention concerns an electrically-powered, dynamic light-emitting gift artifact comprising:
a light emitting component adapted switchably to emit light of two or more different colors,
a translucent substrate window, on which two or more individual layers of artwork are disposed,

wherein:
the light emitting component is located for projection through the translucent substrate, and
the visibility of each layer of artwork in the window changes responsive to emissions by the light emitting component.

The gift artifact may be provided with a plurality of light emitting components, each configured to emit light switchably of two or more different colors, and a corresponding number of translucent substrate windows, each light emitting component individually controllable. For example, the artifact may illuminate each light emitting component sequentially. In addition, the gift artifact may further comprise a sonic transducer configured to reproduced sound that may be synchronized with emissions by the light emitting components.

The electrically-powered gift artifact refers to any product that is typically given as a token of affection or other relationship building and reinforcing reasons of the giving party to the receiving party and which contains electronic components that upon activation produce audio, light and movement effects that may support and enhance the relationship building and -reinforcing purpose of the artifact.

Electronic Components

The electronic components disposed on or in the artifact include the light emitting component, an optional sonic transducer, a processing component such as one or more integrated circuits configured to control the sequence of emissions by the light emitting component, and to synchronise it with optional sound effects.

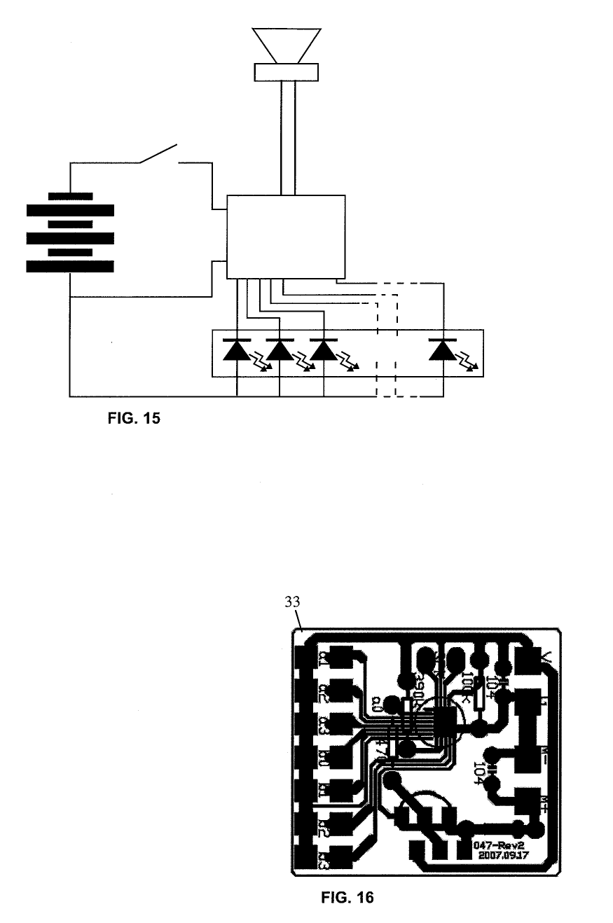

The electronic components are co-operatively connected to function in accordance with the invention. One or more electronic components may be integrated into the same circuit board or integrated into a single integrated circuit. The skilled person would readily be able to prepare the artifact in accordance with the guidance provided herein using standard components and ordinary practices in the art. For general guidance only, circuit diagram and PCB layout illustrated in FIGS. 15 and 16 show possible schemes for connecting electrical components according to the invention.

The artifact may be disposed with one or more (e.g. 2, 3, 4, 5, 6, 7, 8, 9, 10, 11, 12, 13, 14, 15, 16, 17, 18, 19, 20 or more) light-emitting components. A light emitting component is adapted to emit light of two or more different colors switchably. By color, it is meant a particular emission spectral profile in the visible and/or UV range. This provides an overall color appearance to the subject, and is not necessarily limited to a single wavelength of light. Thus, the light emitting component is able to emit light have at least two different spectral profiles. For instance, the light emitting component may be capable of emitting green light having a spectral profile with greatest intensity in the green region of the spectrum, or red light having a spectral profile with greatest intensity in the red region of the spectum, or a mixture of these. The light-emitting component may comprise, for example, a light emitting diode (LED) or an electroluminescent panel or sheet. To achieve a switchable emission, the light-emitting component may comprise two or more separately powered illumination sources, each emitting light of a different spectral profile that can be switched electrically, for example, between two differently colored LEDs, or a single, multi-color LED. The light emitting component may be co-operatively connected to the electronic components, e.g. to a control component, configured to control the timing and/or intensity of the illumination by the light-emitting component. The timing and/or intensity of the illumination may be synchronized with audio emissions from the sonic transducer.

The sonic transducer is configured to receive analogue electrical signals from the electrical components, and reproduce them as sound energy, responsive to the electrical signals. The sound energy is preferably within the frequency range of ordinary human hearing. The sonic transducers may be any, including piezo-electric transducers and magnetic coil transducers; preferably they are piezo-electric audio transducers.

Where the sonic transducer is present, the processing component may be further configured to convert digitalized sound samples stored in a memory into analogue audio signals for output there through. The memory preferably stores a selection of digitized sounds. The electronic components may also include an amplification component for boosting the analogue audio output from the processing component. Alternatively or in addition, the electronic components may include one or more analogue sound generating components, and an optional amplification component for boosting the analogue audio output from the analogue sound-generating component.

Additional electronic components include a power source, to power the electronic components. The power source is preferably a battery, such as a button battery, though it may equally be a solar panel having a flat construction, optionally with a rechargeable battery. Additional electrical components may be one or more electrical contacts (e.g. 1, 2, 3, 4 or 5) or electronic triggering circuits that respond to movement, light or sound impulses, to activate the reproduction of the light effects and the accompanying sounds. Activation may be triggered, for example, by depression of an electrical contact button or upon mechanical opening of a greeting card or book, or particular sounds, a change of light level or the movement of the artifact as a whole. In a preferred aspect of the invention, the artifact is disposed with a single electrical contact that triggers activation of the light-emitting components as well as the sonic transducers.

The translucent substrate provided with multi-layered print artwork refers to a flexible translucent material. Typically it has a thickness of 0.1, 0.2, 0.4, 0.6, 0.8 or 1.0 mm. Because it is translucent, it is permeable to a wide spectrum of light, such as that visible to the human eye. It may also serve to disperse light. The material is such that it allows artwork to be printed on one or both sides.

Typically, the material of the translucent substrate is PP (Polypropylene), formed as a sheet having a thickness of about 0.50 mm. It preferably has a frosted surface finish on at least one side.

Multi-layered print artwork refers to artwork that is printed in 2, 3, 4 or more layers on one or both sides of the translucent substrate. The side of the translucent substrate that is visible to the viewer, is known herein as the top-side of the translucent substrate, and the side of the substrate opposite of the top-side is known as the reverse-side of the substrate. The topmost layer of printed artwork on the topside of the translucent substrate is normally visible to the viewer, also when no light-emitting components are active. This topmost layer of artwork is mentioned as the default artwork layer herein.

Below the default layer, one or more intermediate layers of artwork may be disposed. The intermediate layers may be disposed between the default artwork layer and the substrate. In addition, or alternatively, one or more intermediate layers of artwork may be disposed on the reverse side of the substrate.

Each intermediate layer of artwork may be printed with an ink that has a selective color filtering (blocking) property. This means its has a particular spectral filtering profile in the visible and/or UV range, allowing specific portions of light visible to the human eye to pass through and other portions of the spectrum of light visible to the human eye to be blocked or partially blocked. For example, the ink may allow red light to pass through, but not blue light.

Alternatively, or in addition, the ink may have a luminescent property, i.e. it emits light by absorption of light emitted (radiation) by the light-emitting component. The luminescent ink may be a fluorescent ink (no after glow) or a phosfluorescent ink (with afterglow). The ink may convert a portion of the spectrum of light invisible to the human eye, e.g. ultraviolet light, into light visible to the human eye.

Alternatively, or in addition, the ink may have a photochromic property, i.e. it darkens by absorption of light emitted by the light-emitting component. Typically, photochromic inks are responsive to UV-light.

The wavelengths of light filtered or converted by the layers are matched to the different light profiles emitted by the emitting component placed collocated behind a specific area of the multi-layered artwork for illuminating the multi-layered artwork in that specific area. Each layer of artwork is printed, preferably one above the other, finishing with the topmost layer (default layer). Printing methods that allow overlaying of artwork are known in the art, for instance offset, flexographic or silkscreen printing.

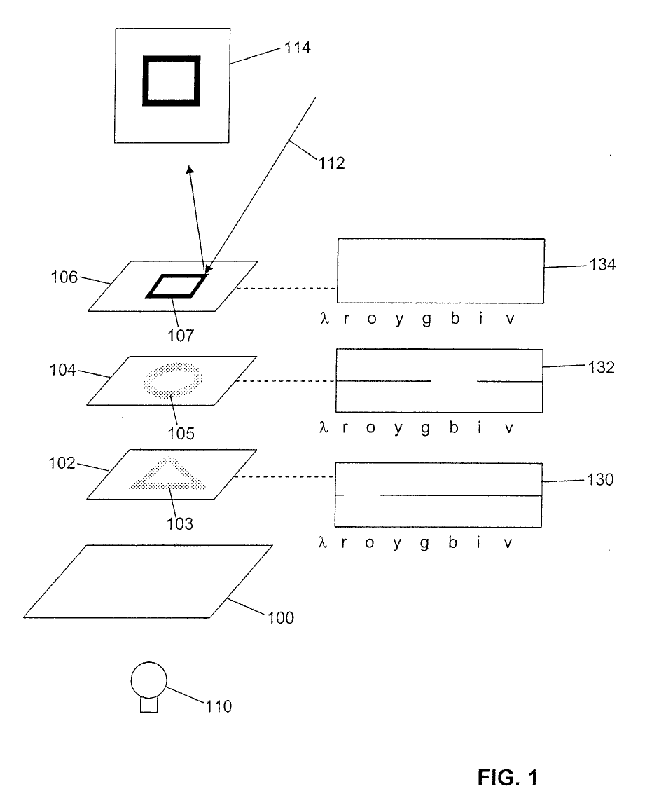

In a non-limiting example shown in FIGS. 1 to 3, an intermediate lower layer 102 of artwork may contain portions printed in ink A 103 and an intermediate upper layer 104 of artwork may contain portions printed in ink B 105. The default layer 106 contains artwork printed in ink C 107. The artwork portions of the lower and upper intermediate layers and the default layer are superimposed.

Behind the substrate 100 of this example, on the reverse side, is a light emitting component 110 placed in alignment with the portions of artwork in the three mentioned layers 102, 104, 106 which component is adapted switchably to emit light having a spectral profile X 120 (property X) and/or light having a spectral profile Y 122 (property Y), where X and Y have the greatest intensity in non-overlapping portions of the spectrum of visible light. Light of property Y has a blue color, while light of property X has a red color.

The light filtering properties 130 of ink A 102 are such that they block the light in the portion of the spectrum Y (blue) and allow light in the portion of the spectrum X (red) to pass through. The filtering properties 132 of ink B are such that they block the light in the portion of the spectrum X (red) and allow light in the portion of the spectrum Y (blue) to pass through. Ink C 107 has no filtering properties 134 and allows light of the whole spectrum to pass through.

When the light emitting component does not emit light (FIG. 1), the default layer 106 is visible by virtue of light reflecting from the surface of the layer, and the “square” pattern is visible 114 to the user.

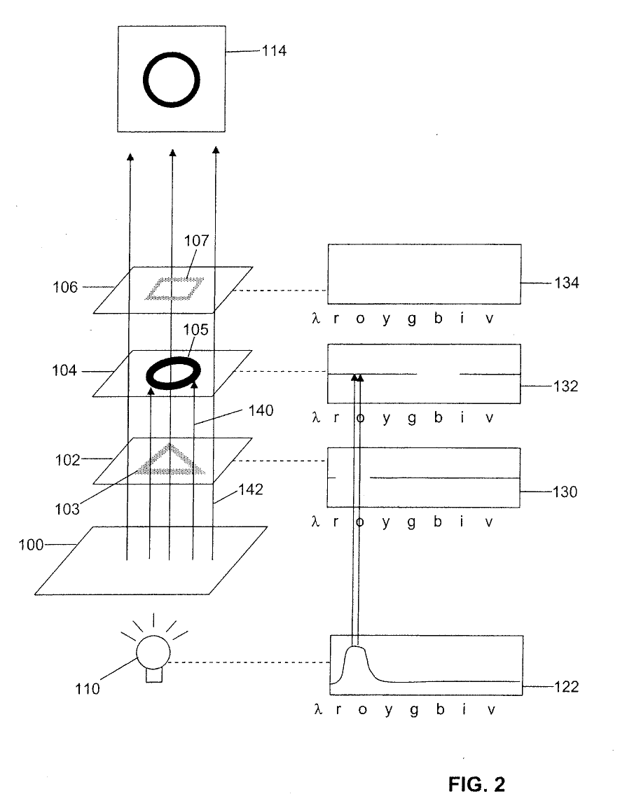

When the light emitting component 110 emits light having a spectral profile X (red) 122 (FIG. 2), ink A 102 of the intermediate lower artwork layer is effectively transparent having a spectral filtering profile 130 that effectively does not block light having a spectral profile X 122. Thus light passes 140, 142, through to the upper intermediate layer 104. Ink B 105 in the upper layer 104 has a spectral filtering profile 132 that effectively blocks light having a spectral profile X (red) 122. Therefore, the artwork printed in the upper intermediate layer 104 appears in silhouette (total filtering) or in a different color and/or intensity (partial filtering). Residual light 142 passing through the upper layer 104 passes through the default layer 106 unhindered since ink C 107 used to print the default layer 106 has no filtering characteristics 134. The result is that the “circle” pattern of the intermediate upper artwork layer 104 is visible 114 to the user.

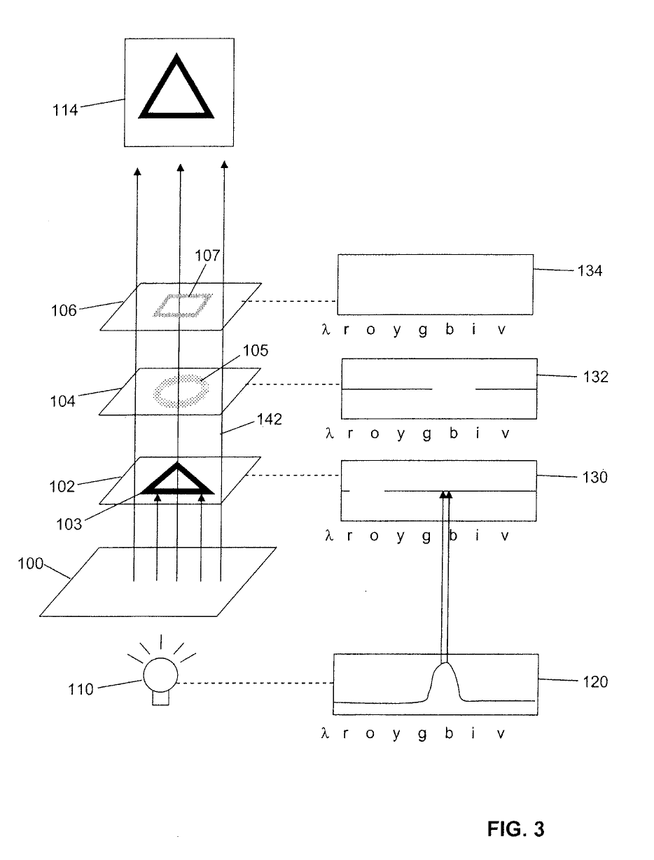

Conversely, when the light emitting component 110 emits light having a spectral profile Y 120 (FIG. 3), ink A 103 of the intermediate lower artwork layer 102 has a spectral filtering profile 130 that effectively blocks light having a spectral profile Y 120. Therefore, the artwork printed in the lower intermediate layer 104 appears in silhouette (total filtering) or in a different color (partial filtering). Ink B 104 of the intermediate upper artwork layer is effectively transparent having a spectral filtering profile 132 that effectively does not block light having a spectral profile Y 120. Thus residual light passes 142, through to the default layer 106. Residual light 142 passing through the upper layer 104 passes through the default layer 106 unhindered since ink C 107 used to print the default layer 106 has no filtering characteristics 134. The result is that the “triangle” pattern of the intermediate lower artwork layer 102 is visible 114 to the user.

Thus artwork in ink with property B to be illuminated by light source with property X, while not being visible when light source with property Y is activated, and artwork in ink with property A to be illuminated by light source with property Y, while not being visible when light source with property X is activated.

The substrate may optionally be provided with a blocking layer. The materials used for printing this blocking-layer are of such a nature that they are impermeable to a wide spectrum of visible light, effectively blocking the light emitted by the light emitting component. Typically the blocking layer is printed on the reverse side of the substrate. The blocking layer may be the bottom-most layer. The blocking layer may not cover the entire substrate, but may leave portions uncovered to form a window. The windowed region allows light to pass through from the reverse-side of the substrate, through the substrate and the other applied layers of artwork. Where the blocking layer, is present, one or more intermediate layers of artwork may be printed between the substrate and blocking layer.

While the window may be present in a blocking layer printed on the substrate, it is equally within the scope of the invention that the window is formed by an aperture in the surface of the artifact, such as an aperture in the card material used to form a greeting card.

Inks as described herein refer to the substances used to mark artwork layers onto the translucent substrate. As mentioned, they have particular filtering, luminescent or photochromic properties.

For filtering light wavelengths between 620 nm and 670 nm, a suitable ink comprises a cyan-transparent ink. For filtering light of other wavelengths than those wavelengths between 490 nm and 540 nm, a suitable ink comprises a magenta-transparent ink. For filtering light of other wavelengths 400 nm and 450 nm, a suitable ink comprises a yellow-transparent ink. Layering as well as mixtures of the above mentioned inks may be used to achieve other filtering properties, resulting in combined wavelength filtering properties. Such inks are readily available from ink suppliers, and may be ordered with specific filtering properties as is well understood by the skilled artisan.

Photochromic inks are readily available from specialty printing ink suppliers, for example Chromatic Technologies, Inc. (CTI). The molecules of the compounds in such inks change shape and hence change in their light reflecting and light absorbing properties. Typically they are responsive to light in the UV spectrum.

Luminescent printing inks, particularly fluorescent inks, usually contain a compound of the class of chemicals known as stilbenes. These chemicals absorb the energy in the (UV) spectrum of for example 315-380 nm and emit them in the bluish light spectrum of 450-550 nm. Other pigments or compounds may be added to adjust the resulting bluish hues towards even longer wavelengths. Such fluorescence inks are often applied for security reasons and are available for instance from www.advanced-ink.com.

Other fluorescent inks are specifically excited with wavelengths of 360 nm to 370 nm and are available in different excitation colors, meaning the visible color produced by a substance or ink. Such inks for example may be obtained from www.angstromtechnologies.com.

The medium is disposed with the aforementioned electronic components, meaning that it carries the electronic components in or on the medium surface. The components may be attached using any means including adhesive, adhesive tape, a staple, a shallow screw, a rivet. The components may be concealed by placement on a surface reverse to that used to display information. Most preferably, the electrical components are sandwiched between two surfaces of the medium e.g. disposed between two sheets of card. Apertures may be present in the medium to allow the passage of sound and/or light energy.

By way of the above mentioned components, the invention provides for an electrically powered dynamic gift artifact containing electronic components that may be disposed within a single integrated circuit that enables the control of light emitting components play-back of sound and for the optional control of the reproduction of the sound through a sonic-transducer, with the characterization that the light emitting components are placed behind a translucent substrate provided with multi-layered print artwork, where the properties of different layers of artwork are precisely matched to the properties of the light emitting components, allowing for a multitude of artwork to be illuminated independently in the same place, resulting in the illusion of animation of the artwork.

A substantially paper based communication medium refers to any communication medium formed from a carrier constructed primarily from one or more sheets of thick paper, cardboard or similar material. It includes, but is not limited to a greeting card, a product or promotional leaflet, book-like product, booklet, bookmark, calendar, or poster etc. The medium will typically be disposed with information that can be read e.g. text, numbers or illustrations.

The invention further provides for a method to support and enrich sound effects produced by a powered dynamic gift artifact resulting in the illusion of animation of portions of the artwork. The method comprises:
providing an electrically powered dynamic gift artifact bearing visual information,
playing back sound electronically stored in electronic components in the paper based communication medium, said sound reproduced through a sonic transducer, and simultaneously driving light-emitting components, where each sound and/or light-effect is synchronized. The synchronization supports or enriches the visual information applied to a surface of the powered dynamic gift artifact,
providing a translucent substrate provided with multi-layered artwork on both sides of the substrate, behind which several individual light emitting components are placed, and of which the properties of the materials used in the consecutive layers of print are precisely matched to the position and the light-emission properties of the light emitting components.

### EXAMPLES

Examples of non-limiting implementations of the invention are provided by way of illustration, in FIGS. 1 to 11.

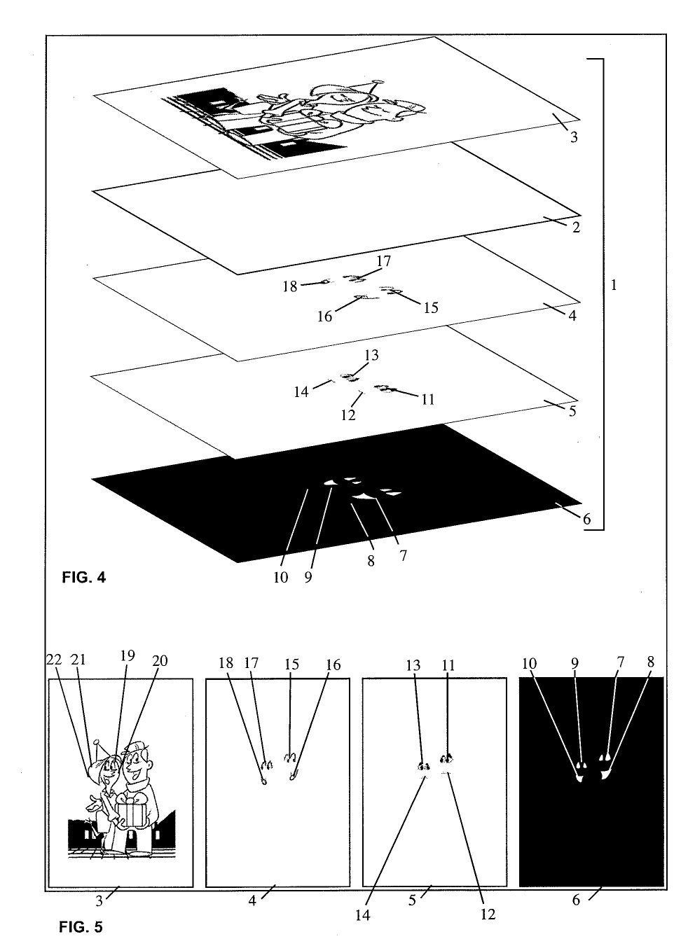

In accordance with an embodiment of the present invention, a substantially paper based communication medium is provided in FIGS. 4 to 9.

FIG. 4 shows a translucent substrate 2 with layers of artwork 3, 4, 5 and 6 that are printed onto the translucent substrate 2. The whole of the translucent substrate with multi-layer printing applied is annotated 1.

FIG. 5 shows the different artwork layers separately. The default state visible to the viewer of the multi-layer artwork is layer 3, showing the default state for one mouth 22, the default state for another mouth 20, the default state for one set of eyes, and the default state 21 and 19 for another set of eyes 19.

An intermediate upper print layer of artwork 4 bears one state of the multi-layer artwork and intermediate lower print layer 5 bears another state of the multi-layer artwork. Intermediate upper print layer of artwork 4, shows artwork depicting one state of the sets of eyes 17, 15 (corresponding to the eyes 21, 19 respectively of the default state 3), and one state of the mouths 18, 16 (corresponding to mouths 22, 20 respectively of the default state 3).

Similarly, an intermediate lower print layer of artwork 5, show artwork depicting another state of the sets of eyes 13, 11 (corresponding to corresponding to the eyes 21, 19 respectively of the default state 3) and another state of the mouths 14, 12) corresponding to mouths 22, 20 respectively of the default state 3).

The bottom layer of artwork is the blocking layer 6, where windows 7, 8, 9 and 10 of the blocking layer are not printed and allow light to pass. The regions have a size and position corresponding to the eyes 13,11 and mouths 12, 14 on layer 5, and to the eyes 15, 17 and mouths 16, 18 on layer 4 and to the eyes 21, 19 and mouths 20, 22 on layer 3.

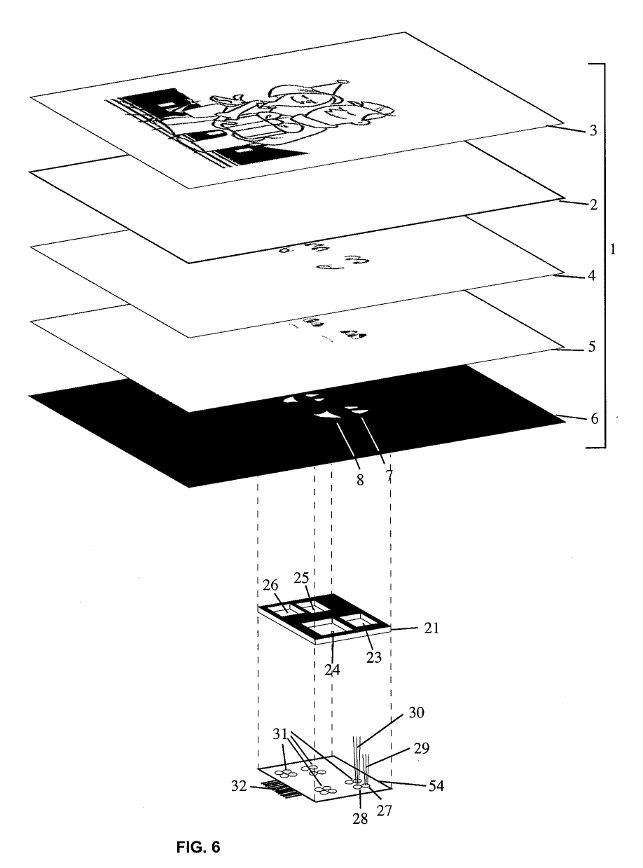

FIG. 6 shows an exploded view of the construction of the multi-layer printed translucent substrate 1 with a piece of spacer 21, and a PCB 54 provided with four light emitting components 31.

The spacer 21 may be made of a material such as polyurethane foam, cardboard or other opaque material and is provided with die-cuts 23, 24, 25 and 26 that align with the windows 7, 8, 9 and 10 and respectively with the eyes 13,11 and mouths 12, 14 of layer 5, and with the eyes 15,17 and mouths 16, 18 of layer 4 and with the eyes 21,19 and mouths 20, 22 of layer 3.

The PCB 54 similarly is provided with sets of light emitting components 31, where each set of light emitting components is placed such as to align with die-cuts 23, 24, 25 or 26 respectively. The PCB 54 has printed circuits that connect the light-emitting components to connection wires 32 for connecting to the rest of the electronic components in such a way that each light-emitting component may be activated switachably and individually.

A light emitting component 31, may comprise, for example, different colored light sources 27 and 28 though it may equally be a multicolor LED. Light source 27 emits light having one spectral profile 29 (e.g. red), whereas light source 28 emits light a having different spectral profile 30 (e.g. blue).

The properties of the materials of the intermediate upper artwork layer 4 are such that they are made visible with light of one spectral profile 30 (e.g. blue) emitted by light source 28, but not with light of another spectral profile 29 (e.g. red) emitted by light source 27.

Similarly, the properties of the materials of intermediate lower artwork layer 5 are such that they are made visible with light of one spectral profile 29 (e.g. red) emitted by light source 27, but the other spectral profile 30 (e.g. blue) emitted by light source 28.

The die-cuts in spacer 21 are placed such that they each limit the dispersion of the light emitted by each light emitting components to the corresponding region of artwork that the die-cut aligns with. That is to say, they shield one window from the other. For example, die-cut 23 aligns with region 7,11,15,19 and limits the light emitted by the set of light emitting component 31 (containing light sources 27 and 28) to that region.

The spacer 21 also provides a gap of 1-2 mm between the light emitting components on PCB 54 and the substrate 1, resulting in more homogenous illumination of the artwork.

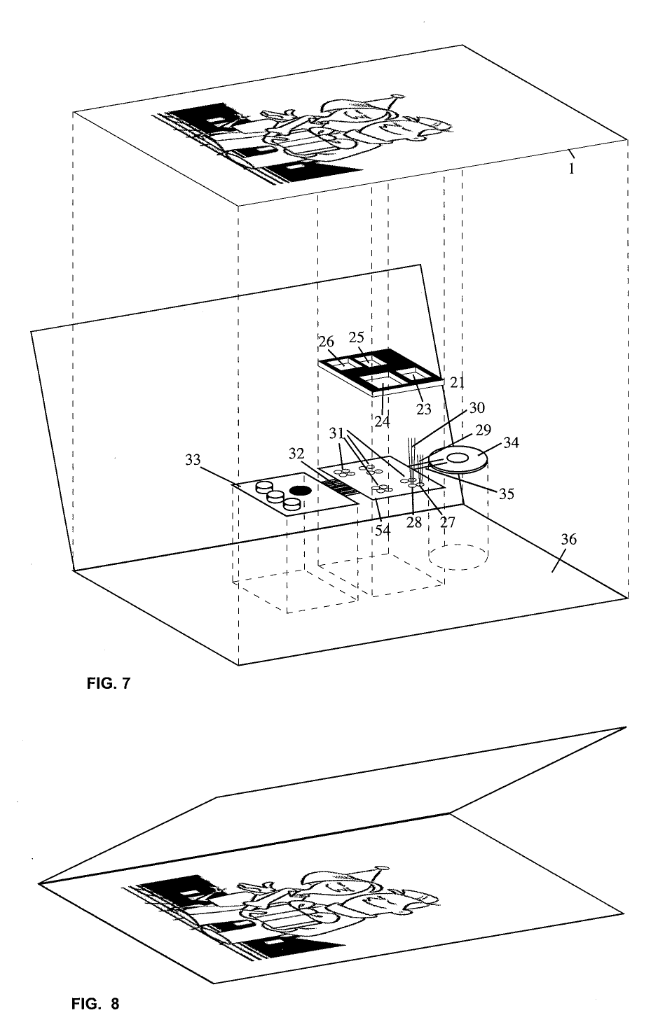

FIG. 7 shows an assembly into the embodiment of a greeting card of the multi-layer printing translucent substrate 1, with the spacer 21, the PCB 33 provided with electronic components connected by electric wires 32 to the PCB 22 provided with light emitting components, and with electrical wires 35 to the sound transducer 34. Connections are soldered, or employ spades or connectors as necessary. The different parts of the artifact are fixed together by means of an adhesive, such as, but not limited to, hot melt glue or double sided tape.

FIG. 8 shows an assembled embodiment of the invention as a greeting card.

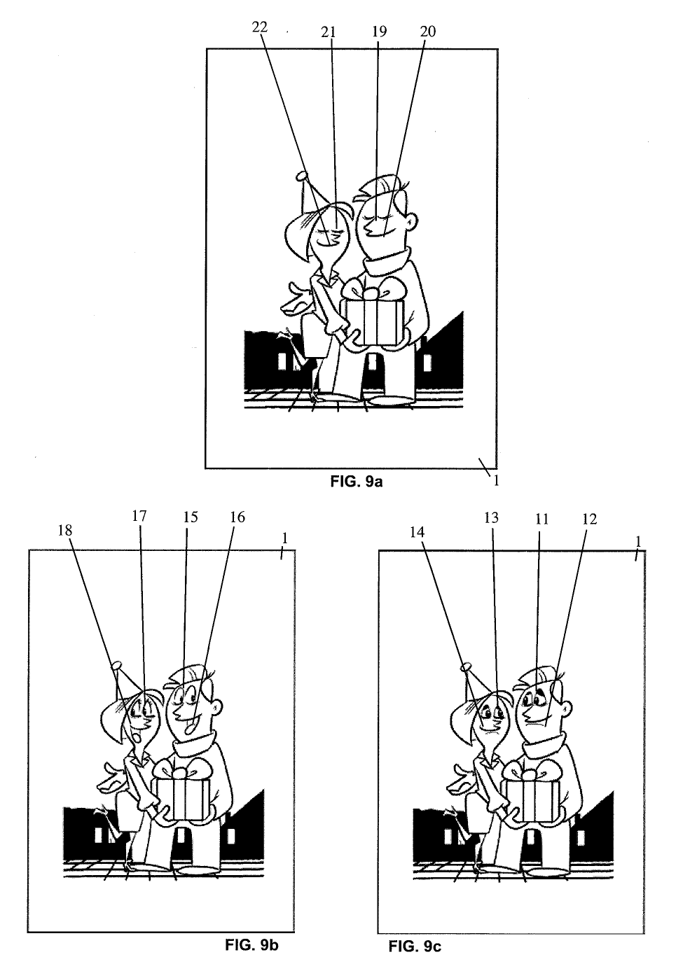

FIG. 9A shows the default state of artwork of FIGS. 1 to 5.

FIG. 9B shows one state of artwork where the emitting components are activated to emit light of a spectral profile that reveals the artwork of layer 4.

FIG. 9C shows another state of artwork where the emitting components are activated to emit light of a spectral profile that reveals the artwork of layer 5.

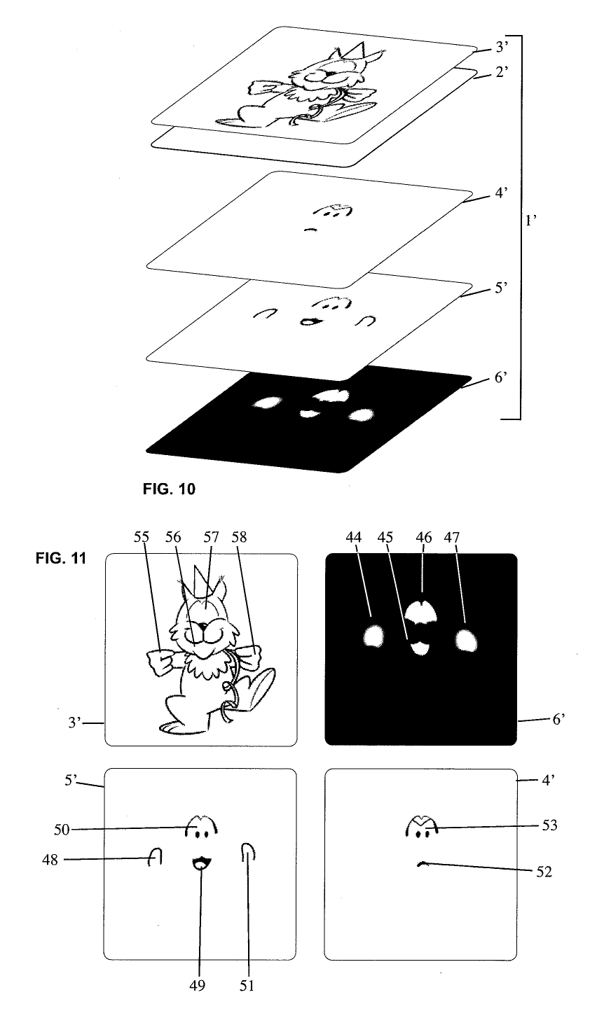

In accordance with another embodiment of the present invention, a gift artifact is provided in FIGS. 10 to 14 that represents a mouse-mat.

FIG. 10 shows a translucent substrate 2′ with layers of artwork 3′, 4′, 5′ and 6′ that are printed onto the translucent substrate 2′. The whole of the translucent substrate with multi-layer printing applied is annotated 1′.

FIG. 11 shows the different artwork layer separately. The default state visible to the viewer of the multi-layer artwork is layer 3′, showing the default state for one mouth 56, the default state for one hand 55, the default state for another hand 58, and the default state for the set of eyes 57.

An intermediate upper print layer of artwork 4′ bears one state of the multi-layer artwork and intermediate lower print layer 5′ bears another state of the multi-layer artwork. Intermediate upper print layer of artwork 4′, shows the another state for the mouth 49, another state for one hand 48, another state for another hand 51 and another state for the set of eyes 50.

Similarly, an intermediate lower print layer of artwork 4′, shows a further state for the mouth 52 and a further state for the set of eyes 53.

The bottom layer of artwork 6′ is the blocking layer, where windows 44, 45, 46 and 47 of the blocking layer are not printed and allow light to pass. These regions have a size and position correspond to artwork states 48, 49, 50 and 51 on layer 5, to artwork states 52 and 52 on layer 4 and to default states 55, 56, 57 and 58 on the top layer 3.

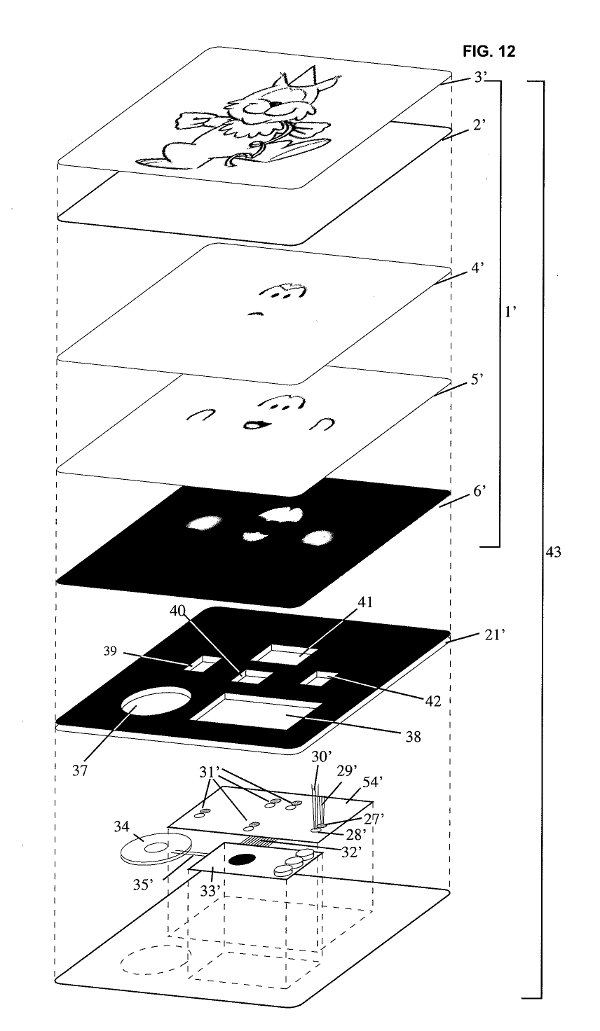

FIG. 12 shows an exploded view of the assembly of all the components of the invention into a gift artifact that is a mouse mat. The different parts of the artifact are fixed together by means of an adhesive, such as, but not limited to, hot melt glue or double sided tape.

The spacer 21′ is made of a material such as PU foam, cardboard or other opaque material and is provided with die-cuts 39, 40, 41 and 42 that align with the regions 44, 45, 46 and 47 of the bottom artwork layer 6′ (48, 49, 50 and 51 of layer 5; 55, 56, 57 and 58 on the top layer 3; and 52 and 53 on layer 4, respectively) and it is provided with die-cuts that align with components 34 and 33′ as to leave space for the thickness of these components.

The PCB 54′ similarly is provided with sets of light emitting components 31, where each set of light emitting components is placed such as to align with die-cuts 39, 40, 41 and 42 respectively. The PCB 54′ has printed circuits that connect the light-emitting components to connection wires 32′ for connecting to the rest of the electronic components on PCB 33′ in such a way that each light-emitting component may be activated individually. The electronic components on PCB 33′ are further connected to a sonic transducer 34 by means of electric wires 35′ for the reproduction of sound.

A set of light emitting component 31′, may comprise, for example, different colored light sources 27 and 28 though it may equally be a multicolor LED. Light source 27′ emits light having one spectral profile 29′ (e.g. red), whereas light source 28′ emits light having a different spectral profile 30′ (e.g. blue).

The properties of the materials of printed artwork layer 4′ are such that they made visible with light of one spectral profile 30′ (e.g. blue) emitted by light source 28′, but not with light of another spectral profile 29′ (e.g. red) emitted by light source 27′.

Similarly, the properties of the materials of printed artwork layer 5′ are such that they are made visible with of one spectral profile 29′ (e.g. blue) emitted by light source 27′, but not with light of the other spectral profile 30′ emitted by light source 29′ (e.g. blue).

The die-cuts in spacer 21′ are placed such that they each limit the dispersion of the light emitted by one set of light emitting components to the corresponding region of artwork that the die-cut aligns with. For example the die-cut 42 aligns with region 47, 51, 58 and limits the light emitted by the set of light emitting component 31′ (containing light soucres 27′ and 28′) to that region,

The spacer 21′ also provides a gap of 1-2 mm between the light emitting components on PCB 54′ and the substrate 1, resulting in more homogenous illumination of the artwork.

FIG. 13 shows an assembled embodiment of the invention as a greeting card.

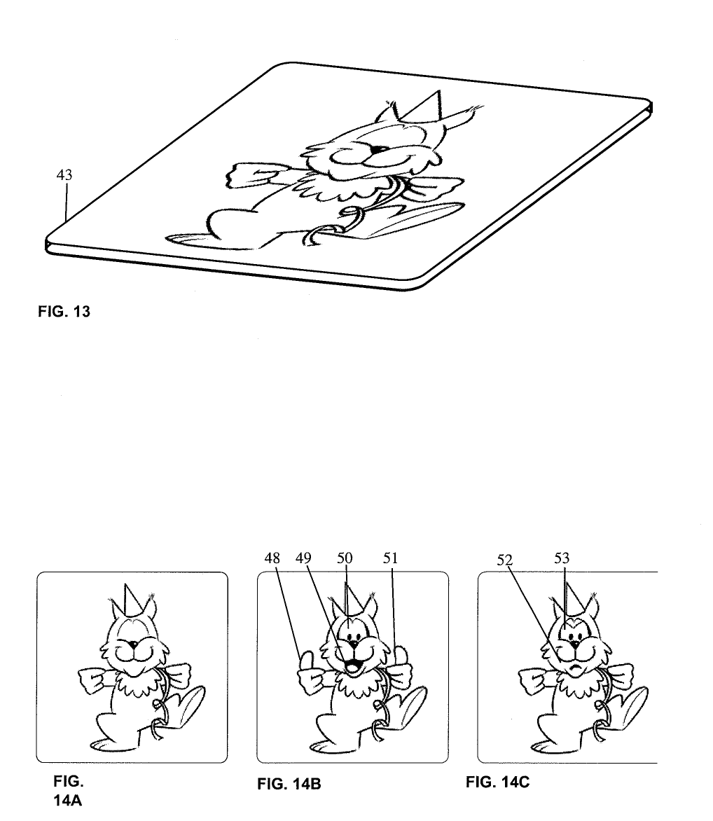

FIG. 14A shows the default state of artwork of FIGS. 10 to 13.

FIG. 14B shows one state of artwork where the emitting components are activated to emit light of a spectral profile that reveals the artwork of layer 5′.

FIG. 14C shows another state of artwork where the emitting components are activated to emit light of a spectral profile that reveals the artwork of layer 4′.

1. An electrically-powered, dynamic light-emitting gift artifact comprising:
a light emitting component adapted switchably to emit light of two or more different colors,
a translucent substrate window on which two or more superimposed layers of artwork are disposed,
wherein:
the light emitting component is located for projection through the translucent substrate, and
the visibility of each layer of artwork in the window changes responsive to emissions by the light emitting component.

2. Artifact according to claim 1, wherein at least one of the layers of artwork is printed using a selective light-filtering ink, where one of the two colors emitted by the light emitting component substantially passes through the ink, and the other of the two colors emitted by the light emitting component substantially does not.

3. Artifact according to claim 1, wherein
a first layer of the overlapping layers of artwork is printed using a first selective light-filtering ink, where a first color emitted by the light emitting component substantially passes through the first ink, and a second color emitted by the light emitting component substantially does not,
a second layer of the overlapping layers of artwork is printed using a second selective light-filtering ink, where the second color emitted by the light emitting component substantially passes through the second ink, and the first emitted by the light emitting component substantially does not.

4. Artifact according to claim 1, wherein at least one of the superimposed layers of artwork is a topmost layer of artwork visible to the viewer without from the light emitting component.

5. Artifact according to claim 2, further comprising a processing component operably connected to the light emitting component, adapted to control the sequence of emissions by the light emitting component.

6. Artifact according to claim 1, wherein the number of light emitting components is 1, 2, 3, 4, 5, 6, 7, 8, 9, 10 or more.

7. Artifact according to claim 1, wherein the light-emitting component comprises two or more separately powered illumination sources, each emitting light of a different color.

8. Artifact according to claim 1, further comprising a sonic transducer, operably connected to the processing component, whereby the processing component is further adapted to synchronise emissions by the light emitting component with emission of sound from the sonic transducer.

9. Artifact according to claim 1, further comprising an activator such an electrical contacts, motion sensor, or microphone.

10. Artifact according to claim 1 that is a greeting card.

11. Artifact according to claim 1 that is a mouse mat.
